(19) United States
(12) Patent Application Publication
(10) Pub. No.: US 2026/0191355 A1
(43) Pub. Date: Jul. 9, 2026

(54) SYSTEMS AND METHOD FOR DELIVERING HOT WATER FOR THE PRODUCTION OF HOT BEVERAGES

(71) Applicant: Odyssey Espresso LLC, Lakewood, CO (US)

(72) Inventors: Ross AINSWORTH, Denver, CO (US); Olivia PLUMB, Hiawassee, GA (US)

(21) Appl. No.: 19/410,299

(22) Filed: Dec. 5, 2025

Related U.S. Application Data
(60) Provisional application No. 63/741,779, filed on Jan. 3, 2025.

(51) Int. Cl. A47J 31/56; A47J 31/30; A47J 31/46; A47J 31/52

(52) U.S. Cl. CPC A47J 31/56; A47J 31/461; A47J 31/469; A47J 31/5251; A47J 31/30; A47J 31/5253

(57) ABSTRACT

One or more systems and methods for providing hot water in the production of infused beverages (e.g., coffee, and/or espresso), to provide increased consistency in relation to the quality, temperatures, and volume of a serving of the infused beverage. The one or more systems provide hot water to a group head, without the use of an electric pump, which allows the variability of temperature within the one or more boilers to compensate for group head temperature, while providing a consistent volume of water independent of changes made to the temperature within the steam boiler.

### CROSS-REFERENCE TO RELATED APPLICATIONS

This application claims the benefit of U.S. Provisional Application No. 63/741,779, filed Jan. 3, 2025, the content of which is herein incorporated by reference in its entirety for all purposes.

### FIELD OF THE DISCLOSURE

This relates generally to systems and methods for providing hot water in the production of infused beverages (e.g., coffee, and/or espresso), to provide increased consistency in relation to the quality, temperatures, and volume of a serving (e.g., single shot, and/or double shot of espresso).

### BACKGROUND OF THE DISCLOSURE

Many forms of coffee beverages are known as far as the forms in which it is consumed. In particular, the brewing of espresso is considered by many as the purist distillation of the coffee bean, and amongst the most recognizable form of coffee which serves as the basis of countless beverages around the world. Many apparatus and methods have been dedicated to the production and pursuit of consistency and quality when producing espresso. The consistency and/or quality of espresso produced can be affected by variables such as, but not limited to: the amount of coffee grounds used, the ground particulate size of the coffee, and/or the temperature of the water, and/or the time of extraction).

The brewing chamber, or “group head”, is configured to receive hot water from the boiler, ground coffee via a basket or “portafilter”, wherein the boiler is configured to provide hot water at pressure to the group head to force through the ground coffee held within the portafilter, resulting in the production of espresso.

Various apparatus and systems of producing espresso include espresso machines of various types (e.g., manual lever machine, spring lever machine, semi-automatic, automatic, and/or super-automatic) require a source of hot water to be pushed through coffee grounds at extraction pressures such as between approximately 7-11 Bar (100-160 psi) and extraction temperatures between approximately 195-205° F. (90-96° C.). Electric pumps and boilers each are commonly used, alone or in combination, across various apparatus to generate pressure and/or to produce hot water for producing espresso. However, the use of electric pumps can be cost prohibitive, and/or unnecessary for use with manual lever and spring lever type espresso machines.

Some existing solutions use a steam boiler, without a pump, to provide hot water to the group head. The group head, adapted for withstanding extraction pressures, is commonly constructed of materials such as steel which have a high thermal mass. As a result, when a group head begins at a temperature below extraction temperatures (e.g., room temperature), a portion of thermal energy of the hot water received from the steam boiler is lost to bringing the group head to an operating temperature near or equal to extraction temperatures. Thus, the variability of the temperature and pressure at the group head results in inconsistent quality and/or volume of espresso corresponding to each production cycle.

A solution to the forementioned problem surrounding the inconsistent quality of espresso seeks to reduce variability of the group head temperature by varying the temperature within one or more boilers (e.g., steam boiler and/or brew boiler) to compensate for a group head temperature being below operating temperatures. For instance, when the group head is at a lower temperature (e.g., room temperatures) the temperature one or more boilers are operated at a higher temperature than when the group head is at an operating temperature. However, by varying the temperature within the one or more boilers, the pressures within the one or more boilers also vary, thus resulting in variation of the internal temperature within the one or more boilers. Accordingly, when the one or more boilers are at a higher temperature, corresponding to a lower group head temperature (e.g., room temperature), the higher temperature results in an increased pressure within the one or more boilers, and accordingly results in the delivery of more water to the group head than when the one or more boilers are at a lower temperature, corresponding to a higher group head temperature (e.g., operating temperature). Thus, the variation in the temperature, pressure and/or volume of water delivered to the group head results in undesirable variability in the resulting extracted beverage.

Accordingly, there is an identified need to provide a method and system for providing hot water to a group head, without the use of an electric pump, which allows the variability of temperature within the one or more boilers to compensate for group head temperature, while providing a consistent volume of water independent of changes made to the temperature within the steam boiler.

### SUMMARY OF THE DISCLOSURE

This relates generally to systems and processes for the brewing, steeping, and/or production of beverages, such as espresso. It is an aspect of the present disclosure to provide consistent temperature and/or pressures to a group head and/or a brew boiler from a hot water source (e.g., steam boiler) without requiring the use of a pump.

In some embodiments, a beverage infusing system including a reservoir, a holding tank having fluid communication with the reservoir, a steam boiler having fluid communication with each of the holding tank and a brew boiler, and/or a group head having fluid communication with the brew boiler. In some embodiments, a method for the operation of system for infusing beverages (e.g., brewing espresso) includes: in accordance with, or in response to, a determination that one or more first criteria are satisfied, including a criterion that is satisfied when the system detects that a water level within the steam boiler is below a first water level threshold (e.g., following a water level drop), the beverage infusing system ceases heating the steam boiler. In some embodiments, while the water level within the steam boiler is below the first water level threshold, in accordance with, or in response to, a determination that one or more second criteria are satisfied, including a criterion that is satisfied when a first threshold of time has elapsed from detecting the drop of the water level in the steam boiler, the beverage infusing system opens a first valve between the steam boiler and the holding tank, thereby equalizing pressure within the steam boiler with pressure within the holding tank. In some embodiments, while the water level within the steam boiler is below the first water level threshold, in accordance with, or in response to, a determination that one or more second criteria are satisfied, including a criterion that the system detects that water level within the reservoir is greater than a second water level threshold, the beverage infusing system opens a first valve between the steam boiler and the holding tank, thereby equalizing pressure within the steam boiler with pressure within the holding tank. In some embodiments, in accordance with, or in response to, the one or more second criteria being satisfied, the beverage infusing system opens a second valve between the holding tank and the steam boiler, resulting in the flow of water from within the holding tank, to the steam boiler. In some embodiments, in accordance with, or in response to, a determination that the one or more first criteria are no longer satisfied, the beverage infusing system closes the first valve and the second valve. In some embodiments, a beverage infusing system comprises a reservoir comprising a first water level sensor. In some embodiments, a beverage infusing system comprises a holding tank having fluid communication with the reservoir, via a first line including a first valve. In some embodiments, a beverage infusing system comprises a steam boiler comprising a second water level sensor, a first temperature sensor, a first pressure sensor, and/or a first heater, wherein the steam boiler has fluid communication with the holding tank, via a second line including a second valve, and/or a third line including a third valve. In some embodiments, a fluid interconnection of the second line with the holding tank is located higher than a fluid interconnection of the third line with the holding tank. In some embodiments, a fluid interconnection of the second line with the steam boiler is located in a top aspect of the steam boiler. In some embodiments, the fluid interconnection of the third line with the holding tank is located higher than a fluid interconnection of the third line with the steam boiler. In some embodiments, a beverage infusing system comprises a brew boiler comprising a second temperature sensor, wherein the brew boiler has fluid communication with the steam boiler, via a fourth line including a fourth valve. In some embodiments, a beverage infusing system comprises a group head comprising a third temperature sensor, wherein the group head has fluid communication with the brew boiler, via a fifth line including a fifth valve.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1 illustrates an electronic device that utilizes temperature data of a temperature sensing system according to some examples of the disclosure.

FIG. 2 illustrates a system view of a beverage infusing system that utilizes temperature data of a temperature sensing system according to some examples of the disclosure.

FIG. 3 illustrates a flowchart of a method for operation of certain embodiments of a beverage infusing system.

### DETAILED DESCRIPTION

In the following description of examples, reference is made to the accompanying drawings which form a part hereof, and in which it is shown by way of illustration specific examples that can be practiced. It is to be understood that other examples can be used, and structural changes can be made without departing from the scope of the disclosed examples.

In some embodiments, a beverage infusing system including a reservoir, a holding tank having fluid communication with the reservoir, a steam boiler having fluid communication with each of the holding tank and a brew boiler, and/or a group head having fluid communication with the brew boiler. In some embodiments, a method for the operation of system for infusing beverages (e.g., brewing espresso) includes: in accordance with, or in response to, a determination that one or more first criteria are satisfied, including a criterion that is satisfied when the system detects that a water level within the steam boiler is below a first water level threshold (e.g., following a water level drop), the beverage infusing system ceases heating the steam boiler. In some embodiments, while the water level within the steam boiler is below the first water level threshold, in accordance with, or in response to, a determination that one or more second criteria are satisfied, including a criterion that is satisfied when a first threshold of time has elapsed from detecting the drop of the water level in the steam boiler, the beverage infusing system opens a first valve between the steam boiler and the holding tank, thereby equalizing pressure within the steam boiler with pressure within the holding tank. In some embodiments, while the water level within the steam boiler is below the first water level threshold, in accordance with, or in response to, a determination that one or more second criteria are satisfied, including a criterion that the system detects that water level within the reservoir is greater than a second water level threshold, the beverage infusing system opens a first valve between the steam boiler and the holding tank, thereby equalizing pressure within the steam boiler with pressure within the holding tank. In some embodiments, in accordance with, or in response to, the one or more second criteria being satisfied, the beverage infusing system opens a second valve between the holding tank and the steam boiler, resulting in the flow of water from within the holding tank, to the steam boiler. In some embodiments, in accordance with, or in response to, a determination that the one or more first criteria are no longer satisfied, the beverage infusing system closes the first valve and the second valve. In some embodiments, a beverage infusing system comprises a reservoir comprising a first water level sensor. In some embodiments, a beverage infusing system comprises a holding tank having fluid communication with the reservoir, via a first line including a first valve. In some embodiments, a beverage infusing system comprises a steam boiler comprising a second water level sensor, a first temperature sensor, a first pressure sensor, and/or a first heater, wherein the steam boiler has fluid communication with the holding tank, via a second line including a second valve, and/or a third line including a third valve. In some embodiments, a fluid interconnection of the second line with the holding tank is located higher than a fluid interconnection of the third line with the holding tank. In some embodiments, a fluid interconnection of the second line with the steam boiler is located in a top aspect of the steam boiler. In some embodiments, the fluid interconnection of the third line with the holding tank is located higher than a fluid interconnection of the third line with the steam boiler. In some embodiments, a beverage infusing system comprises a brew boiler comprising a second temperature sensor, wherein the brew boiler has fluid communication with the steam boiler, via a fourth line including a fourth valve. In some embodiments, a beverage infusing system comprises a group head comprising a third temperature sensor, wherein the group head has fluid communication with the brew boiler, via a fifth line including a fifth valve.

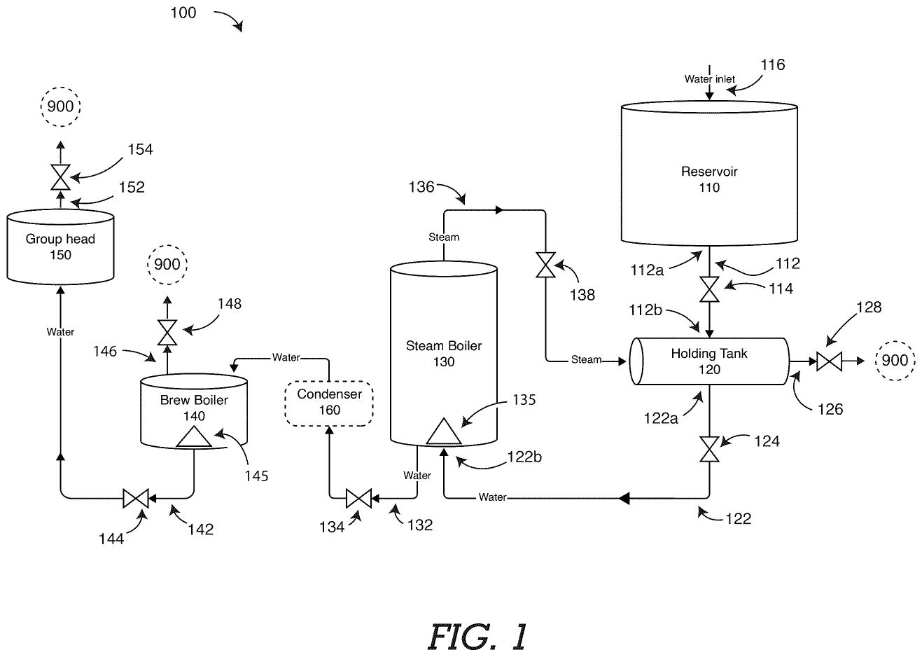

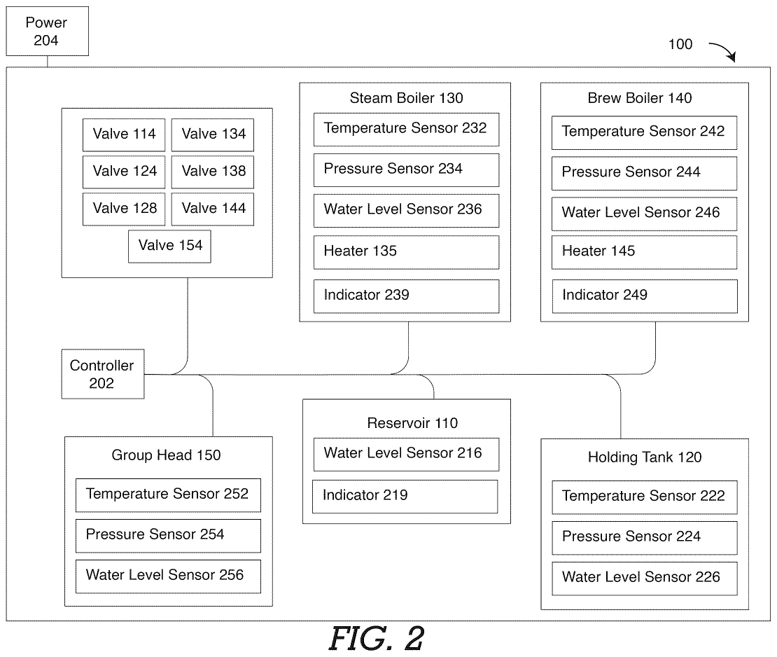

In some embodiments, as shown in FIG. 1-FIG. 2 for instance, a system 100 includes a reservoir 110, and a holding tank 120 having fluid communication with the reservoir 110 via a fluid communication line 112, wherein the fluid communication line 112 includes a valve 114 which is configured to control the fluid communication between the reservoir 110 and the holding tank 120. In some embodiments, a steam boiler 130 has fluid communication with the holding tank 120 via a first fluid communication line 122, wherein the first fluid communication line 122 includes a first valve 124 configured to control the fluid communication between the steam boiler 130 and the holding tank 120. In some embodiments, a brew boiler 140 has fluid communication with the steam boiler 130 via a fluid communication line 132, wherein the fluid communication line 132 includes a valve 134 which is configured to control the fluid communication between the steam boiler 130 and the brew boiler 140. In some embodiments, a group head 150 has fluid communication with the brew boiler via a fluid communication line 142, wherein the fluid communication line 142 includes a valve 144 which is configured to control the fluid communication between the brew boiler 140 and the group head 150. In some embodiments, one or more of the reservoir 110, the holding tank 120, the steam boiler 130, the brew boiler 140, and/or the group head 150 comprise a pressure vessel configured to hold water, steam, and/or air at pressures above atmospheric pressure. In some embodiments, one or more of the pressure vessels is configured to hold pressures 100 kPa, 150 kPa, 200 kPa, 300 kPa, 500 kPa, or greater than 500 kPa therein. In some embodiments, a fluid communication line 152, controlled by valve 154, provides fluid communication between the group head 150 and the 900 ambient atmosphere such as for the purposes of bleeding air from the group head 150 when pressurized water fills the chamber thus omitting air from the extraction process. In some embodiments, valve 154 comprises a one-way valve (e.g., check valve) to allow pressure and/or fluid to travel within the fluid communication line 152 from the group head 150 toward the ambient atmosphere, but not in the reverse direction. In some embodiments, a one-way valve as referenced herein is configured to restrict the flow of liquid between two aspects (e.g., the brew boiler 150, and the ambient atmosphere 900) in one or more directions, while allowing passage of gases (e.g., pressurized air) in the one or more directions. For instance, in some embodiments valve 154 is configured to prevent the passage of water therethrough, such as while the group head 150 is pressurized, while air is permitted to pass through the valve 154 from the group head to the ambient atmosphere 900 while the group head is under pressure.

In some embodiments, a user optionally fills the reservoir 110, via a water inlet 116, prior to and/or after powering on the system. The reservoir is optionally configured to hold 25 mL, 60 mL, 150 mL, 500 mL, 1 Liter, 1.5 Liters, 4 Liters, or more than 4 Liters. When filling the reservoir, the user optionally fills the reservoir at least above a reservoir low water threshold. In some embodiments, the system 100 optionally does not perform certain processes (e.g., brewing a beverage, refilling the holding tank, etc.) when the system detects, via a water level sensor (e.g., 216, 226, 236, 246, and/or 256), that the level of the water within one or more components (e.g., reservoir, holding tank, steam boiler, brew boiler, and/or group head) are equal to or below a respective low water level threshold such as the reservoir low water level threshold. In some embodiments, the reservoir low water level threshold of the reservoir corresponds to a volume of 0 mL, 25 mL, 60 mL, 150 mL, 500 mL, 1 Liter, or more than 1 Liter.

In some embodiments, water optionally flows from the reservoir 110 to the holding tank 120 until the system detects, via a water level sensor 226, that the amount of water within the holding tank is equal or greater than a holding tank water level threshold. In some embodiments, the holding tank water level threshold corresponds to the volumetric capacity of the holding tank 120. Additionally or alternatively, the holding tank threshold of water optionally shares one or more characteristics with the forementioned reservoir low water level threshold. In some embodiments, the flow of water between the reservoir 110 and the holding tank 120 is controlled via a valve 114 configured to control liquid flow between the reservoir 110 and the holding tank 120. While some embodiments described herein surround eliminating a pump from the system 100, it is within the spirit and scope of the present disclosure to generate flow between the reservoir and the holding tank via a pumping mechanism. Additionally or alternatively, in some embodiments the flow between the reservoir 110 and the holding tank 120 is generated via gravitational flow based on the fluid communication line 112 interconnecting the reservoir and the holding tank, having an interconnection 112a with the reservoir which is located higher than an interconnection 112b with the holding tank “Gravitational flow,” as used herein, relies at least partially upon the absolute level of the a source tank (e.g., the reservoir) being higher than the absolute level of the receiving tank (e.g., the holding tank). Accordingly, when flow is permitted (e.g., valve 114 is opened) through the fluid communication line 112 interconnecting the reservoir 110 with the holding tank 120, the water flows from the reservoir 110 to the holding tank 120 based on gravitational flow (e.g., potential energy). In some embodiments, when the system 100 is powered off, the valve 114 between the reservoir 110 and the holding tank 120 is in an open configuration to allow the passive flow of water from the reservoir 110 to the holding tank 120 based on gravitational flow. Additionally or alternatively, in some embodiments, the flow of water from the reservoir 110 to the holding tank 120 is initiated and/or at least partially driven by virtue of a pressure differential between the reservoir and the holding tank wherein the pressure within the holding tank is less than the pressure within the reservoir.

Valves, as described with the system and/or method of the current disclosure, surround the use of a flow limiting and/or regulating device. In some embodiments a valve is manually actuated and/or actuated through anon-manual (e.g., remote, automatic, and/or semi-automatic) manner. Non-manual actuation of the valves optionally includes control signals provided from a controller 202 which optionally opens and/or closes the one or more valves. In some embodiments, a valve is actuated through the use of electronic mechanism (e.g., piezoelectric), electromechanical mechanism (e.g., servo, stepper motor, solenoid, etc.), and/or pneumatic mechanism. In some embodiments, one or more valves of the system are in a closed configuration when power is not supplied to the valve and/or the system. Additionally or alternatively, one or more valves of the system are in an open configuration when the power is not supplied to the valve and/or the system.

In some embodiments, when pressure within the holding tank 120 is equal to or higher than the pressure within the steam boiler 130, the system allows water to flow from the holding tank 120 to the steam boiler 130 via a first fluid communication line 122 extending between the holding tank 120 and the steam boiler 130. The first fluid communication line 122 optionally includes a first valve 124 which is configured to control the fluid communication between the steam boiler 130 and the holding tank 120. In some embodiments, (e.g., when first valve 124 is in an open configuration) the water flows from the holding tank 120 to the steam boiler 130 by virtue of interconnection 122a of the first fluid communication line with the holding tank 120, being located higher in comparison to the interconnection 122b of the fluid communication line with the steam boiler 130. Accordingly, when pressure within the steam boiler and pressure within the holding tank are equalized (e.g., via a second fluid communication line 136 extending between the steam boiler 130 and the holding tank 120), water flows via gravitational flow from the holding tank toward the steam boiler. Additionally or alternatively, when the system detects, via a water level sensor 236, that water within the steam boiler 130 is below a steam boiler water level threshold, the system refills the steam boiler by allowing water to flow (e.g., by opening first valve 124) from the holding tank 120 to the steam boiler 130. In some embodiments, the steam boiler water level threshold is based on a volumetric amount of water which shares one or more characteristics with the reservoir low level threshold as disclosed herein. Additionally or alternatively, the steam boiler water level threshold is optionally based on a height of water contained within the steam boiler 130. In some embodiments, the height of the water within the steam boiler 130 corresponding to the steam boiler water level threshold corresponds to a height of 5 mm, 2 cm, 5, cm, or more than 5 cm.

In some embodiments, when power 204 is provided to the system 100, the steam boiler 130 is heated, via a heater 135 interconnected with the steam boiler, until a temperature sensor 232 configured to detect a temperature corresponding to the temperature within the steam boiler detects a steam boiler temperature threshold associated with the steam boiler. The steam boiler temperature threshold optionally corresponds to a temperature of 80° C., 90° C., 100° C., 150° C., or greater than 150° C. In some embodiments, the steam boiler temperature is predetermined and/or set by a user and/or developer. In some embodiments, the steam boiler 130 further comprises a pressure sensor 234 configured to detect the pressure within the steam boiler 130. In some embodiments, while the steam boiler is heated, the first valve 124 between the holding tank and the steam boiler is closed.

In some embodiments, when power 204 is provided to the system 100, the brew boiler 140 is heated, via a heater 145 interconnected with the brew boiler, until a temperature sensor configured to detect a temperature corresponding to the temperature within the brew boiler detects a brew boiler temperature threshold associated with the brew boiler 140. The brew boiler temperature threshold optionally shares one or more characteristics with the steam boiler temperature threshold described herein. In some embodiments, the brew boiler temperature threshold is predetermined and/or set by a user and/or developer. In some embodiments, while the brew boiler is heated, a valve 134 controlling fluid communication through a fluid communication line 132 between the steam boiler 130 and the brew boiler 140 is closed by the system 100. In some embodiments, the valve 134 controlling fluid communication between the steam boiler and the brew boiler comprises a one-way valve (e.g., check valve) configured to prevent backflow of fluid and/or pressure in the direction of the steam boiler within the fluid communication line 132. Additionally or alternatively, the one-way valve is configured to allow the flow of fluid and/or pressure from the steam boiler 130 in the direction of the brew boiler 140 when the pressure differential between the steam boiler and the brew boiler exceeds a cracking pressure of the valve 134.

In some embodiments, when the system 100 detects temperatures associated with the brew boiler 140 equal to or greater than the brew boiler temperature threshold, detects temperatures associated with the steam boiler as equal to or greater than the steam boiler temperature threshold, and/or detects that pressures within the steam boiler are equal to or greater than a steam boiler threshold pressure (e.g., 1 bar, 1.5 bar 2 bar, or 2.5 bar), the system 100 opens the valve 134 between the steam boiler 130 and the brew boiler 140, thereby allowing water and/or steam to flow, due to pressure differential, from the steam boiler to the brew boiler. Additionally or alternatively, the flow of water and/or steam is optionally driven by virtue of a pressure differential wherein the pressure within the steam boiler 130 is greater than the pressure within the brew boiler 140, and/or by virtue of flow due to gravity. In some embodiments, when the system detects that the pressure within the steam boiler, via pressure sensor 234, has reached a predetermined pressure, and/or detects that the temperature within the steam boiler, via temperature sensor 232, has reached a predetermined temperature the system alerts (e.g., via an illuminated light (e.g., indicator 239, and/or indicator 249), and/or other notification method) that the system is prepared to initiate brewing a beverage (e.g., extract espresso). In some embodiments, the equalized pressures of the steam boiler 130 and the brew boiler 140 are greater than atmospheric pressures (e.g., approximately 101 kPa). In some embodiments, pressure within the steam boiler 130 and/or the pressure within the brew boiler 140 is maintained through actuation of the heater 135 interconnected with the steam boiler and/or the heater 145 interconnected with the brew boiler.

In some embodiments, when the system receives user input (e.g., pulling a lever, pressing a button, and/or opening a valve 144) the system optionally flows water from the brew boiler 140, via pressurized flow, to the group head 150, via a fluid communication line 142, thus depleting the water (e.g., heated water) held within the brew boiler 140. In some embodiments, when the water flows from the steam boiler 130 to the brew boiler 140, the system detects that the water level within the steam boiler 130 falls below the steam boiler water level threshold, and accordingly, the system closes the valve 134 between the steam boiler 130 and the brew boiler 140. While the valve 134 between the steam boiler and the brew boiler is closed, and the steam boiler water level is above the steam boiler water level threshold, the system 100 heats the steam boiler 130 by activating the heater 135 interconnected with the steam boiler, thereby maintaining and/or increasing temperature and/or pressure within the steam boiler 130. Additionally or alternatively, in some embodiments, the valve 134 between the steam boiler and the brew boiler includes a one-way valve (e.g., check-valve) which is configured to allow flow of pressure and/or fluids therethrough from the steam boiler toward the brew boiler when the pressure within the steam boiler is at a predetermined steam boiler operating pressure threshold, and greater than the pressure within the brew boiler. In some embodiments, the steam boiler operating pressure threshold shares one or more characteristics with the steam boiler high pressure threshold as disclosed herein. In some embodiments, following a predetermined period of time (e.g., 5 seconds, 10 seconds, 30 seconds, or 2 minutes) from when the water level within the steam boiler 130 is detected as being below the steam boiler water level threshold, the system optionally opens a second valve 138, configured to control the fluid communication between the steam boiler 130 and the holding tank 120 via a second fluid communication line 136, to release pressure from the steam boiler 130 to the holding tank 120, thereby equalizing the pressures within the steam boiler and the holding tank. In some embodiments, the system opening the second valve 138 between the steam boiler is conditionally dependent on the system detecting, via water level sensor 156 interconnected with the reservoir 110, that the water level within the reservoir is above a reservoir low level threshold (e.g., not zero, and/or contains volume of water equivalent to the holding tank water level threshold). In some embodiments, while the second valve 138 interconnecting the steam boiler 130 with the holding tank 120 is open, the system opens a valve 128 which controls fluid communication between the holding tank 120 and the ambient atmosphere 900, is opened to release pressure from the holding tank 120 and/or the steam boiler 130. In some embodiments, opening the valve 128 occurs after the steam boiler 130 has been refilled, such as through the first fluid communication line 122 interconnecting between the holding tank and the steam boiler. When the system opens the second valve 138 between the steam boiler 130 and the holding tank 120, the system optionally ceases heating (e.g., deactivates heater 135) of the steam boiler 130.

In some embodiments, when the pressure between the steam boiler 130 and the holding tank 102 are equalized, the system 100 opens the first valve 124 between the holding tank 120 and the steam boiler 130, allowing water to flow, via the first fluid communication line 122, from the holding tank 120 to the steam boiler 130. In some embodiments, the water flows from the holding tank 120 to the steam boiler 130 by virtue of the interconnection 122a of the first fluid communication line with the holding tank being located higher than the interconnection 122b of the first fluid communication line with the steam boiler. In some embodiments, at least a portion of the holding tank 120 is located higher than a portion of the steam boiler 130 thus allowing the gravitational flow of water from the holding tank 120 to the steam boiler 130 via the first fluid communication line 122. The system optionally provides water flow, via gravitational flow, from the holding tank 120 to the steam boiler 130 while the water level within the steam boiler, detected by water lever sensor 236, continues to be below the steam boiler water level threshold.

In some embodiments, after the filling of the steam boiler 130 from the holding tank 120 is initiated, when the system detects, via the water lever sensor 236, that the water level within the steam boiler 130 is equal to or greater than the steam boiler water level threshold, the system closes the first valve 124 and the second valve 138, thereby ceasing fluid communication between the holding tank 120 and the steam boiler 130. When the system ceases fluid communication between the holding tank 120 and the steam boiler 130, the system optionally initiates heating, via the heater 135 interconnected with the steam boiler 130, the water within the steam boiler. In some embodiments, system heats the water within the steam boiler to the steam boiler temperature threshold, wherein the heating of the water within the steam boiler increases the temperature and/or the pressure within the steam boiler 130. In some embodiments, the system does not actuate the heater 135 of the steam boiler unless the first valve 124 and the second valve 138 are closed.

In some embodiments, while the steam boiler 130 is in a heated state (e.g., while the heading element is active, and/or after the steam boiler reaches the steam boiler temperature threshold) the system 100 opens the valve 134 between the steam boiler 130 and the brew boiler 140 thus allowing fluid flow between the steam boiler 130 and the brew boiler 140 by virtue of a pressure differential wherein the pressure within the steam boiler 130 is greater than the pressure within the brew boiler 140. In some embodiments, wherein the valve 134 comprises a one-way valve (e.g., check valve) the fluid flows from the steam boiler toward the brew boiler by virtue of a pressure differential between the steam boiler and the brew boiler, exceeding a cracking pressure of the valve 134. In some embodiments, while the valve 134 between the steam boiler 130 and the brew boiler 140 is open, the pressure within the brew boiler and the pressure within the steam boiler are nominally equal (e.g., within 5% pressure differential). When the second valve 138, controlling the flow of fluids via the second fluid communication line 136, is open, the pressure within the steam boiler 130 is optionally lower than the pressure within the brew boiler 140. Additionally or alternatively, in some embodiments wherein the valve 134 comprises a one-way valve, the valve 134 prevents the loss of pressure from the brew boiler toward the steam boiler. Opening the valve 134 between the steam boiler 130 and the brew boiler 140 optionally results in an increase of pressure within the brew boiler. In some embodiments, a condenser 160 (e.g., passive condenser, and/or active condenser), such as a cooling coil, which interconnected with the fluid communication line 132 interconnecting the steam boiler 130 and the brew boiler 140, cools water content to limit the amount of steam volume within the brew boiler 140.

In some embodiments, when the valves (e.g., first valve 124, and/or second valve 138) between the steam boiler 130 and the holding tank 120 are closed, and the system detects that the steam boiler 130 has reached the steam boiler temperature threshold, the system indicates (e.g., via an illuminated light (e.g., indicator 239, and/or indicator 249), and/or other notification method) that the system is prepared to initiate brewing a beverage (e.g., extract espresso) and/or provide steam for processes such as steaming milk.

In some embodiments, when the valves (e.g., first valve 124, and/or second valve 138) between the holding tank 120 and the steam boiler 130 are closed, the system 100 opens the valve 128 controlling fluid communication through the fluid communication line 126 between the holding tank 120 and the ambient atmosphere 900, allowing the pressure within the holding tank 120 to be reduced and/or equalized with respect to the ambient atmosphere 900. Following the reduction of pressure within the holding tank 120, the system optionally opens the valve 114 controlling fluid communication, via fluid communication line 112, between the reservoir 110 and the holding tank 120, thereby allowing water within the reservoir 110 to flow to the holding tank 120. In some embodiments, the valve 114 comprises a one-way valve (e.g., check-valve) which is configured to allow flow of pressure and/or fluids therethrough from the reservoir toward the holding tank. In some embodiments, the flow of water from the reservoir 110 to the holding tank 120 occurs by gravitational flow and/or virtue of the fluid communication line 112 between the holding tank 120 and reservoir 110 having an interconnection 112a with the reservoir 110 that is located higher than the interconnection 112b of the fluid communication line with the holding tank 120. In some embodiments, at least a portion of the reservoir 110 is located higher than a portion of the holding tank 120.

In some embodiments, when the system detects, via water level sensor 236, that the water level in the steam boiler is below a steam boiler low water threshold (e.g., empty, 5 mL, 10 mL, 20 mL, 50 mL, or 100 mL), the system ceases heating of the steam boiler (e.g., via heater 135) and/or the brew boiler (e.g., via heater 145). Additionally or alternatively, while the system detects that the water level in the steam boiler 130 is below the steam boiler low water threshold, the system prevents the activation of the heater 135 interconnected with the steam boiler and/or the heater 145 interconnected with the brew boiler. In some embodiments, when the system 100 detects the water level within the steam boiler 130 is below the steam boiler low water threshold, and detects the water level within the reservoir as below a reservoir low water threshold (e.g., empty, less than the volume of the holding tank, or less than the volume of water require to refill the steam boiler to the steam boiler water level threshold), the system 100 foregoes and/or does not allow activation of the heater 135 within the steam boiler, and/or the activation of the heater 145 within the brew boiler.

In some embodiments, when the system detects, via the pressure sensor 234 interconnected within the steam boiler, that the pressure within the steam boiler 130 exceeds a steam boiler high pressure threshold (e.g., 100 kPa, 250 kPa, 500 kPa, 1 MPa, or more than 1 MPa) the system ceases heating of the steam boiler in order to reduce the possibility of a failure event such as bursting of the steam boiler 130. In some embodiments, when the system detects that the water volume is below the steam boiler low water threshold, the system ceases heating of steam boiler 130 to reduce the possibility of an overheating failure event. In some embodiments, when the system 100 detects, via pressure sensor 244 interconnected with the brew boiler 140, that the pressure within the brew boiler exceeds a brew boiler high pressure threshold, the system 100 opens a valve 148 controlling fluid communication between the brew boiler 140 and the ambient atmosphere 900 in order to reduce the pressure within the brew boiler and/or to reduce the possibility of a failure event. In some embodiments, the brew boiler high pressure threshold shares one or more characteristics with the steam boiler high pressure threshold as disclosed herein. In some embodiments, when the system detects, via pressure sensor 234 interconnected with the steam boiler 130, that the pressure within the steam boiler 130 exceeds the steam boiler high pressure threshold, the system optionally opens the valve 134 between the steam boiler 130 and the brew boiler 140.

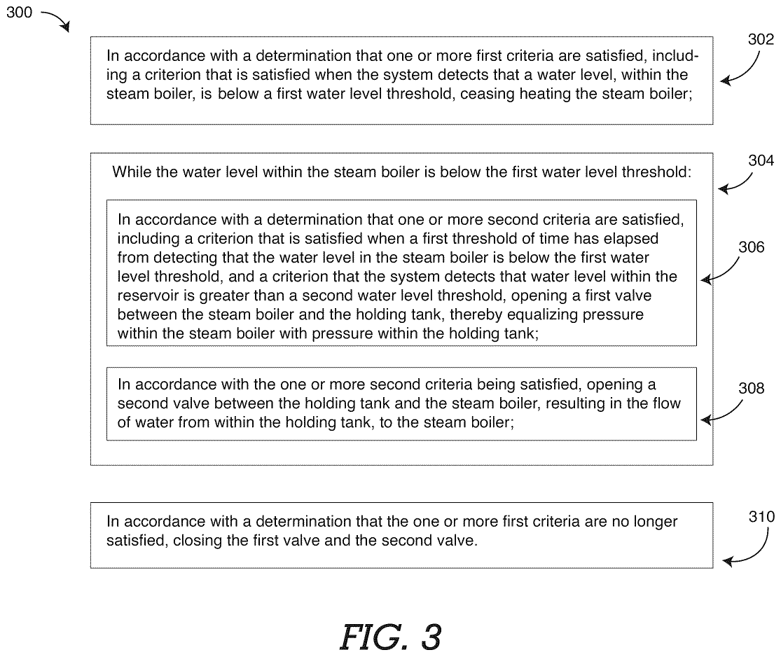

In some embodiments, as illustrated in FIG. 3 for instance includes a method 300 for the operation of a system for infusing beverages (e.g., producing espresso). In some embodiments, the method 300 includes in accordance with, or in response to, a determination that one or more first criteria are satisfied, including a criterion that is satisfied when the system detects the water level is below a predetermined water level (e.g., steam boiler water level threshold) within the steam boiler (e.g., steam boiler 130 at FIG. 1) water level threshold, the beverage infusing system (e.g., system 100 at FIG. 1) ceases heating 302 the steam boiler. In some embodiments, while the water level within the steam boiler is below the first water level threshold, in accordance with, or in response to, a determination that one or more second criteria are satisfied, including a criterion that is satisfied when a first threshold of time has elapsed from detecting the drop of the water level in the steam boiler, the beverage infusing system opens 306 a first valve (e.g., first valve 124 at FIG. 1) between the steam boiler and the holding tank (e.g., holding tank 120 at FIG. 1), thereby equalizing pressure within the steam boiler with pressure within the holding tank. In some embodiments, while the water level within the steam boiler is below the first water level threshold 304, in accordance with, or in response to, a determination that one or more second criteria are satisfied, including a criterion that the system detects that water level within the reservoir is greater than a second water level threshold, the beverage infusing system opens 306 a valve (e.g., second valve 138 at FIG. 1) between the steam boiler and the holding tank, thereby equalizing pressure within the steam boiler with pressure within the holding tank. In some embodiments, while the water level within the steam boiler is below the first water level threshold 304, in accordance with, or in response to, the one or more second criteria being satisfied, the beverage infusing system opens a second valve 308 (e.g., first valve 124 at FIG. 1) between the holding tank and the steam boiler, resulting in the flow of water from within the holding tank, to the steam boiler. In some embodiments, in accordance with, or in response to, a determination that the one or more first criteria are no longer satisfied, the beverage infusing system closes 310 the first valve and the second valve.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings, including the combination of any of the forementioned embodiments. The examples were chosen and described in order to best explain the principles of the disclosure and its practical applications, to thereby enable others skilled in the art to best use the disclosure and various described examples with various modifications as are suited to the particular use contemplated.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. (canceled)

2. A beverage infusing system comprising:
a reservoir comprising a first water level sensor;
a holding tank having fluid communication with the reservoir, via a first line including a first valve;
a steam boiler comprising:
a second water level sensor, a first temperature sensor, a first pressure sensor, and a first heater, the steam boiler having fluid communication with the holding tank, via a second line including a second valve, and a third line including a third valve,
wherein a fluid interconnection of the second line with the holding tank is located higher than a fluid interconnection of the third line with the holding tank,
wherein a fluid interconnection of the second line with the steam boiler is located in a top aspect of the steam boiler, and
wherein the holding tank is configured to allow gravitational flow of fluids from the holding tank to the steam boiler;
a brew boiler comprising a second temperature sensor, the brew boiler having fluid communication with the steam boiler, via a fourth line including a fourth valve; and
a group head comprising a third temperature sensor, the group head having fluid communication with the brew boiler, via a fifth line.

3. A beverage infusing system comprising:
a holding tank configured to hold fluids;
a steam boiler having fluid communication with the holding tank via:
a first fluid communication line, with a first valve, configured to allow flow of the fluids from the holding tank toward the steam boiler, and
a second fluid communication line, with a second valve, configured to allow the flow of steam from the steam boiler toward the holding tank; and
a brew boiler, configured to receive the fluids from the steam boiler via a third fluid communication line, which includes a third valve,
wherein when a pressure within the steam boiler is greater than a pressure within the brew boiler, the first valve and the second valve are closed, and the third valve is open, at least a portion of the fluids within the steam boiler flows from the steam boiler to the brew boiler.

4. The beverage infusing system of claim 3, wherein the third valve prevents backflow from the brew boiler toward the steam boiler, the system further comprising:
a group head having fluid communication with the brew boiler via a fourth fluid communication line, with a fourth valve, wherein when the pressure of the brew boiler is greater than a pressure of the group head, at least a portion of the fluids in the brew boiler flows from the brew boiler toward the group head.

5. The beverage infusing system of claim 4, further comprising a fifth fluid communication line, including a fifth valve, configured to allow gasses to travel from the group head toward an ambient atmosphere.

6. The beverage infusing system of claim 5, wherein the fifth valve is configured to prevent passage of the fluids from the group head toward the ambient atmosphere.

7. The beverage infusing system of claim 3, wherein the third fluid communication line further comprises a condenser configured to cool the fluids as they flow from the steam boiler toward the brew boiler.

8. The beverage infusing system of claim 3, further comprising a reservoir in fluid communication with the holding tank via a fourth fluid communication line, wherein the holding tank is configured to receive the fluids from the reservoir via the fourth fluid communication line by gravitational flow.

9. The beverage infusing system of claim 3, wherein the holding tank further comprises a fourth fluid communication line, with a fourth valve, configured to allow gasses to travel from the holding tank to an ambient atmosphere.

10. The beverage infusing system of claim 3, further comprising a heater configured to heat the steam boiler,
wherein when the system detects, via a fluid level sensor interconnected to the steam boiler, that a fluid level within the steam boiler is less than a first level threshold, the system prevents activation of the heater.

11. The beverage infusing system of claim 3, wherein when the system detects, via a fluid level sensor interconnected to the steam boiler, that a fluid level within the steam boiler is less than a first level threshold, the system opens the first valve, thereby allowing flow of the fluids from the holding tank toward the steam boiler.

12. The beverage infusing system of claim 11, wherein when the system detects that the fluid level within the steam boiler is less than the first level threshold, the system opens the second valve thereby allowing steam and pressure to flow toward the holding tank.

13. The beverage infusing system of claim 3, wherein when the system detects, via a fluid level sensor interconnected to the steam boiler, that a fluid level within the steam boiler is less than a first level threshold; and
detects that the second valve is open, and the first valve is closed, the system opens the first valve, thereby allowing pressure flow between the steam boiler and holding tank, and fluid flow from the holding tank toward the steam boiler.

14. The beverage infusing system of claim 13, wherein the flow of fluids between the steam boiler and the holding tank occurs due to gravitational flow.

15. The beverage infusing system of claim 13, wherein the fluid flow between the steam boiler and the holding tank occurs due to a pressure differential between the steam boiler and the holding tank.

16. The beverage infusing system of claim 15, wherein when the system detects that fluid level within the steam boiler reaches the first level threshold, the system closes the first valve and the second valve.

17. The beverage infusing system of claim 13, wherein when the system detects that fluid level within the steam boiler reaches the first level threshold, the beverage infusing system opens a fourth valve configured to reduce pressure within the holding tank via flow of pressure from the holding tank toward an ambient atmosphere.

18. The beverage infusing system of claim 13, wherein the holding tank is configured to receive fluids via a fourth fluid communication line, and wherein the reduction of pressure within the holding tank results in the flow of fluids through the fourth fluid communication line into the holding tank.

19. The beverage infusing system of claim 18, wherein the fourth fluid communication line is interconnected to a fluid reservoir.
